(19) United States
(12) Patent Application Publication
(10) Pub. No.: US 2002/0147601 A1
(43) Pub. Date: Oct. 10, 2002

(54) Lease arrangements for providing computer equipment

(76) Inventor: Von E. Fagan, Meridian, ID (US)

Correspondence Address: PERKINS COIE LLP, PATENT-SEA, P.O. BOX 1247, SEATTLE, WA, 98111-1247, US

(21) Appl. No.: 09/828,446

(22) Filed: Apr. 5, 2001

(51) Int. Cl. G06F 17/60

(52) U.S. Cl. 705/1

(57) ABSTRACT

A system and method in a computer system for providing computer equipment to customers. The method can include combining components of the computer equipment and leasing the computer equipment to a customer in return for a payment from the customer corresponding at least in part to the length of time the customer leases the computer equipment. The method can further include receiving an indication from the customer that the lease is terminated after an arbitrary, customer-selected time period has elapsed, and without incurring a penalty to the customer. The computer equipment can then be received back from the customer and re-leased or sold to another customer. At least one of the computer components can be leased from a component vendor by receiving the computer component from the vendor and paying the vendor at predetermined intervals a periodic vendor payment. The vendor payment can correspond to the cost of the computer component multiplied by an interest rate factor and divided by a total number of predetermined intervals that elapse until a value of the component is zero. The method can further include continuing to pay the periodic vendor payment after the total number of predetermined intervals has elapsed (for example, if the computer equipment is still leased to a customer), or paying the vendor for a remaining value of the computer component (for example, if the computer equipment in which the component is installed is sold to a customer). Accordingly, the method can provide flexibility to customers who may wish to return computer equipment at an arbitrary point in time. The method can benefit vendors because they may receive periodic payments that, when compiled, exceed the value of the leased component.

### TECHNICAL FIELD

The following disclosure relates generally to systems and methods for providing computer equipment to customers.

### BACKGROUND

Computer customers typically purchase computer equipment (such as personal computers) from manufacturers, wholesalers, or retailers. One drawback with this approach is that the computers can become outdated relatively quickly, due to rapid technology advances in the computer industry. One approach to addressing this drawback is to lease computer equipment to the customer for a fixed period of time. For example, manufacturers can lease computers to the customer in return for a series of periodic payments spread out over the term of the lease. At the end of the term, the customer can renew the lease or return the equipment to the manufacturer. The manufacturer can optionally upgrade the equipment and re-lease it to another customer.

One drawback with the foregoing lease arrangement is that the term of the lease may be too long in light of the rapid pace of technological development in the computer industry. Accordingly, the customer may have to choose between breaking the lease before the end of the term (and paying a penalty for doing so), or operating with obsolete equipment until the end of the lease term. Another drawback (when the manufacturer is the lessor) is that the manufacturer must typically pay “up front” for the components that are assembled into the computer, but receives a return on the up front investment that is delayed over the life of the lease. Accordingly, providing new computer equipment to customers can place a short-term capital strain on the manufacturer.

### BRIEF DESCRIPTION OF THE DRAWINGS

FIG. 1 is a block diagram illustrating a system in accordance with an embodiment of the invention.

FIG. 2A is a flow diagram illustrating the operation of several elements shown in FIG. 1 in accordance with an embodiment of the invention.

FIG. 2B is a flow diagram illustrating a method for providing computer components in accordance with an embodiment of the invention.

FIG. 2C is a flow diagram illustrating a method for providing computer equipment in accordance with an embodiment of the invention.

FIGS. 3A-3G are flow diagrams illustrating methods for providing computer equipment in accordance with other embodiments of the invention.

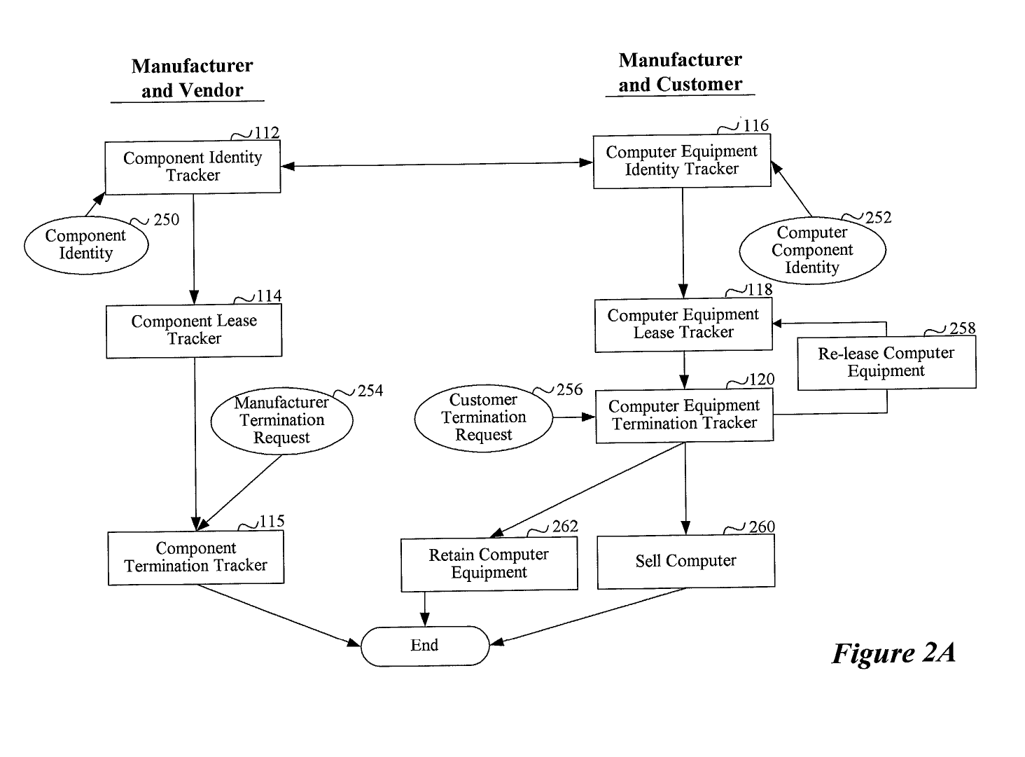

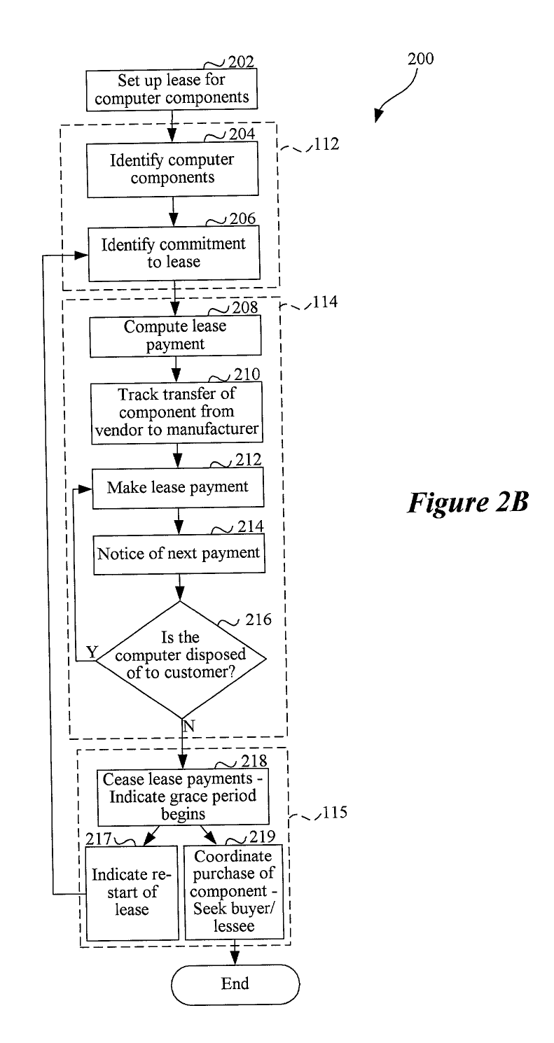

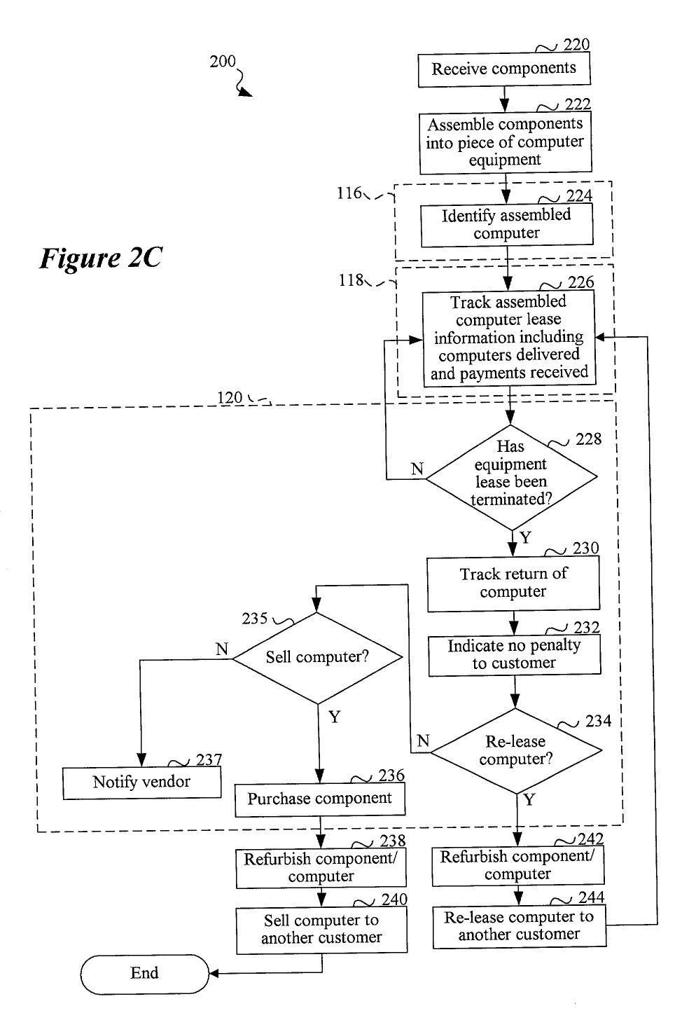

In the drawings, identical reference numbers identify identical or substantially similar elements or steps. To readily identify the discussion of any particular element or step, the most significant digit or digits in a reference number refer to the Figure number in which that element is first introduced (e.g., step 204 is first introduced and discussed in FIG. 2).

### DETAILED DESCRIPTION

The following disclosure describes a system and method for providing computer equipment to customers. In one embodiment, the method includes assembling components of the computer equipment and leasing the computer equipment to the customer. The customer pays an amount corresponding at least in part to the length of time the customer leases the computer equipment. The method further includes receiving an indication from the customer that the lease is terminated after an arbitrary, customer-selected period of time has elapsed. The customer incurs no penalty for terminating the lease after the arbitrary time period. The computer equipment is then received back from the customer. In one aspect of this embodiment, the method can further include selling the computer equipment to another customer, or leasing the computer equipment to another customer in return for another payment that corresponds at least in part to a length of time the other customer leases the computer equipment.

In another embodiment, the method includes leasing at least one of the components of the computer equipment from a vendor by receiving the component from the vendor and paying the vendor a periodic vendor payment at predetermined intervals. The vendor payment can correspond to the cost of the component multiplied by an interest rate factor and divided by a number of time intervals that elapse until the value of the component is zero. The method can further include purchasing the computer component from the vendor after a selected number of time intervals have passed and after paying a selected number of periodic vendor payments. The purchase price of the component can correspond to a remaining value of the computer component.

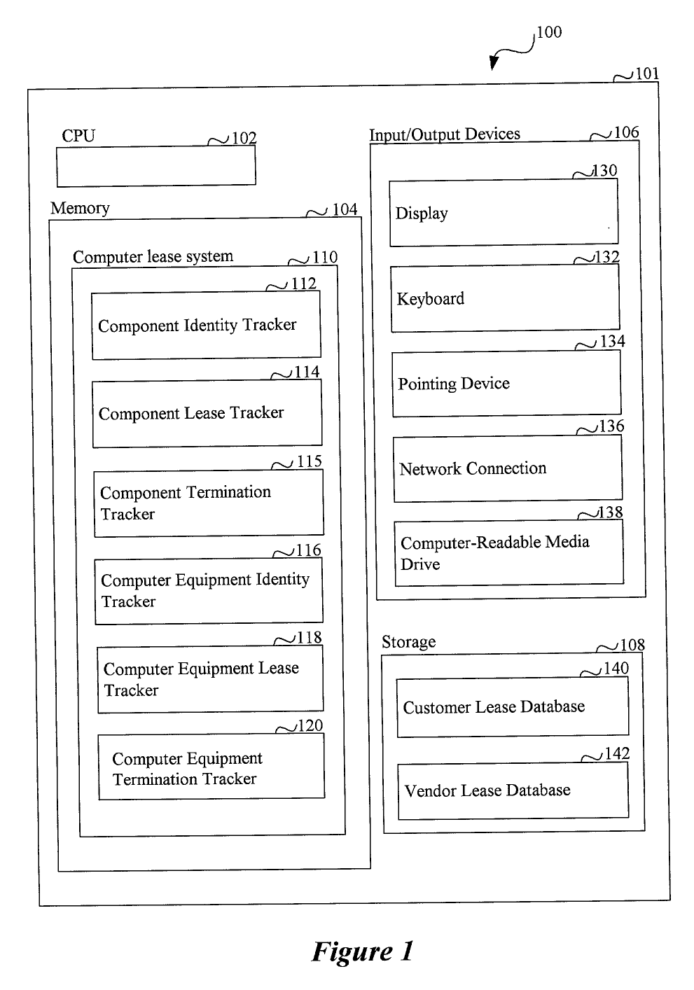

Many specific details of certain embodiments of the invention are set forth in the following description and in FIGS. 1-3G to provide a thorough understanding of these embodiments. One skilled in the art, however, will understand that the present invention may have several additional embodiments, or that the invention may be practiced without several of the details described below.

Although not required to practice the invention, embodiments of the invention may take the form of computer-executable instructions, such as routines executed by a general-purpose computer (e.g., a server or personal computer). Those skilled in the relevant art will appreciate that the invention can be practiced with other computer system configurations, including Internet appliances, hand-held devices (including palm top computers, wearable computers, cellular or mobile phones, multiprocessor systems, processor-based or programmable consumer electronics, set-top boxes (such as for use with television sets), network PCs, mini-computers, mainframe computers and the like). The invention can be embodied in a special-purpose computer or data processor that is specifically programmed, configured or constructed to perform one or more of the computer-executable instructions explained in detail below. Accordingly, the term “computer” as generally used herein, refers to any of the above devices as well as any data processor.

The invention can also be practiced in distributed computing environments, where tasks or modules are performed by remote processing devices that are linked through a communications network. In a distributed computing environment, program modules or sub-routines may be located in both local and remote memory storage devices. Aspects of the invention described below may be stored or distributed on computer-readable media, including magnetic and optically readable and removable computer disks, as well as distributed electronically over the Internet or over other networks (including wireless networks). Data structures and transmissions of data particular to aspects of the invention are also encompassed within the scope of the invention.

FIG. 1 schematically illustrates a system 100 for providing computer equipment to a customer or other end user in accordance with an embodiment of the invention. In one aspect of this embodiment, the system 100 identifies and tracks computer components leased by a computer manufacturer from a component vendor. The system 100 can also identify and track the computer equipment assembled by the manufacturer from the computer components and leased to the customer or end user. The customer can terminate the lease at an arbitrary, customer-selected point in time without penalty and return the computer equipment to the manufacturer. The manufacturer can then re-lease or sell the computer equipment to another customer. Each of these events and related information can be tracked by the system 100, as described in greater detail below.

In one embodiment, many aspects of the operations described above can be performed by a computer. Accordingly, the system 100 can include a computer 101 that has a CPU 102, a memory 104, input/output devices 106, and a storage device 108. The memory 104 can include software or other computer instructions for implementing a method in accordance with an embodiment of the invention. For example, the software can include a computer lease system 110 that has a component identity tracker 112 for identifying components of the computer equipment, a component lease tracker 114 for tracking lease information corresponding to the components, a component termination tracker 115 for tracking termination of the component lease, a computer identity tracker 116 for tracking the identity of the computer equipment assembled from the components, a computer lease tracker 118 for tracking lease information corresponding to the computer equipment, and a computer equipment termination tracker 120 for tracking termination of the computer lease.

The input/output devices 106 can include a display 130, a keyboard 132, a pointing device 134, and a computer-readable media drive 138. Accordingly, the computer 101 can read computer-readable media having the software for the component identity tracker 112, the component lease tracker 114, the component termination tracker 115, the computer identity tracker 116, the computer lease tracker 118, and/or the computer termination tracker 120. The software can also be accessible from the memory 140, as described above. Alternatively, the software can be accessible over a network via a network connection 136.

The storage device 108 can include file storage for items such as customer lease information and vendor lease information. Accordingly, the storage device 108 can include a customer lease database 140 to store information related to the lease of the computer equipment to the customer, and a vendor lease database 142 to store information related to the lease of the components of the computer equipment from the vendor.

FIG. 2A is flow diagram illustrating the operation of several of the elements described above with reference to FIG. 1, in accordance with an embodiment of the invention. In general, the relationship between the manufacturer and the vendor is shown in the left-hand column of FIG. 2A, and the relationship between the manufacturer and the customer is shown in the right-hand column of FIG. 2A. In one aspect of this embodiment, the component identity tracker 112 receives the identity 250 of a computer component and provides the identity information to the component lease tracker 114. The component identity information can also be provided to the computer equipment identity tracker 116 to correlate the identity of the component with the identity of the equipment in which the component is installed. The component lease tracker 114 tracks the status of the lease of the computer component. The component termination tracker 115 can receive a manufacturer's termination request 254 and terminate the lease between the manufacturer and the vendor, ending their relationship for that component.

The computer equipment identity tracker 116 receives the identity 252 of a piece of computer equipment and provides the identity to the computer equipment lease tracker 118 and, optionally, to the component lease tracker 114. The computer equipment lease tracker 118 tracks the progress and status of the lease of the computer equipment to the customer, and the computer equipment termination tracker 120 can receive a customer termination request 256 to terminate the lease between the manufacturer and the customer. The manufacturer can then re-lease the computer (step 258), sell the computer (step 260) or retain the computer (step 262).

As described in greater detail below, an advantage to the customer of the foregoing arrangement is that the lease between the customer and the manufacturer can be terminated at an arbitrary point in time, giving the customer greater flexibility in upgrading or otherwise changing computer equipment. An advantage to the manufacturer is that the components incorporated into the computer equipment can be leased from the vendor, reducing the initial capital outlay for these components. A further advantage is that the lease may be terminated at the manufacturer's request if the computer equipment is not disposed of to a customer. An advantage to the vendor is that the manufacturer may commit to a greater number of components under this arrangement than under conventional arrangements. A further advantage is that the vendor may continue to receive a revenue stream from components incorporated into equipment that is disposed to customers, even after the components have been fully depreciated.

FIGS. 2B and 2C are flow diagrams of representative implementations of a process 200 performed at least in part by the system 100 and in particular, by the computer 101 described above with reference to FIG. 1. To illustrate the processes performed by the computer 101, many of the process operations are described in the context of individual routines implemented on the computer 101. Many of the processes can be performed by the tracker routines described above with reference to FIGS. 1 and 2A and as indicated in dashed lines in FIGS. 2B and 2C. Alternatively, these routines can perform more or fewer of the steps surrounded by dashed lines. One skilled in the relevant art will appreciate that each of these processes will typically be implemented as several separate routines or subroutines, or may be combined in larger routines or programs.

The processes shown in FIG. 2B correspond generally to the lease arrangement between the vendor (or other entity supplying computer components) and the manufacturer or assembler (or other entity assembling the computer components). The processes shown in FIG. 2C correspond generally to the lease arrangement between the manufacturer or assembler and the customer or end-user of the assembled computer equipment. In one embodiment, many of the processes illustrated in FIG. 2B can be performed on a computer under the vendor's control, and many of the processes illustrated in FIG. 2C can be performed on a computer under the manufacturer's control. In other embodiments, a single computer can perform all the computer-based processes shown in FIGS. 2B and 2C, or the processes can be distributed in accordance with other arrangements.

Beginning with step 202 (FIG. 2B), the computer component vendor and the computer equipment manufacturer can set up a lease arrangement for the computer components. The components can include input/output devices, storage devices, printed circuit boards, processors and/or other elements of computer equipment. The component identity tracker 112 can track the identity, number and location of the components. In one embodiment, the component identity tracker 112 can identify the computer components (step 204) and can identify a commitment by the manufacturer to lease a selected number of components from the vendor (step 206). An advantage to the vendor of this arrangement is that the manufacturer may commit to obtaining a larger number of components than the manufacturer would commit to under a conventional purchase arrangement because the cost of the components is spread out over the term of the lease. An advantage to the manufacturer is that the initial capital outlay for the components is less than that of a conventional purchase arrangement.

In step 208, the component lease tracker 114 can compute a periodic lease payment for the component. In one aspect of this embodiment, the periodic payment can be computed according to the following formula:

P=(1+I)*C/L

where

P=a periodic payment (such as a monthly payment)

I=an interest rate

C=the cost of the computer component

L=the life of the component, (i.e., the number of periods that must elapse before the remaining value of the component is zero)

In step 210, the tracker 114 tracks and/or stores in a database information relating to the transfer of the components from the vendor to the manufacturer, and in step 212, the manufacturer makes a lease payment for the component. In step 214, the lease tracker 114 notifies the manufacturer that the next lease payment is due. In step 216, component lease tracker 114 (and/or the computer equipment lease tracker 118) determines whether or not the computer equipment in which the component resides is or will shortly be disposed of to a customer. For example, if the equipment is leased to the customer (as described in greater detail below), then the manufacturer continues to make lease payments (step 212), even if the initial term of the lease (e.g., 36 months) has expired and/or even if the total of the lease payments exceeds the value of the component. Alternatively, the manufacturer can purchase the component from the vendor. In either embodiment, if the equipment is not disposed of to a customer, by lease or sale, the manufacturer can cease making lease payments for the duration of a grace period (step 218), which can be indicated by the component termination tracker 115. In one aspect of this embodiment, the duration of the grace period can be from one to three months, and in other embodiments, the grace period can have other terms. At the end of the grace period, the manufacturer can restart the component lease (indicated by the system 100 step 217) or purchase the component from the vendor (coordinated by the system 100 step 219), and continue to seek buyers or lessees for the computer equipment in which the component is installed.

Accordingly, one feature of this arrangement (for example, when the computer equipment is leased to one or more customers for a long period of time) is that the vendor can continue to receive lease payments beyond the initial term of the component lease and/or beyond the expected life of the component. An advantage of this arrangement is that the vendor may receive more revenue for the component than under a conventional purchase arrangement. An advantage to the manufacturer is that the manufacturer pays a lower up front cost for the component and does not pay for the component (at least for the duration of the grace period) when the equipment in which the component is installed is not generating revenue for the manufacturer.

Turning now to the lease arrangement between the computer manufacturer and the customer (FIG. 2C), the computer manufacturer receives the computer components from the vendor (step 220) and assembles or otherwise incorporates the components into a piece of computer equipment (step 222). The assembled piece of computer equipment can include a personal computer, or alternatively, a notebook computer, a server or another computer device. In one embodiment, the computer equipment identity tracker 116 identifies the assembled computer equipment in step 224. In one aspect of this embodiment, the computer equipment identity tracker 116 can be coupled to the component identity tracker 112 to track the relationship between components of the computer equipment and the computer equipment itself. In a further aspect of this embodiment, the computer equipment identity tracker 116 and the component identity tracker 112 can be routines or subroutines of a single computer program and can operate on the same computer. Alternatively, the computer equipment identity tracker 116 and the component identity tracker 112 can operate on separate platforms.

In either of the embodiments described above, the computer lease tracker 118 can track information pertaining to the lease of the computer equipment to the customer (step 226). For example, the computer equipment lease tracker 118 can track the identity of the customer to whom the computer equipment is leased, the type and serial number of the computer equipment leased, and the status of the customer's account, including the number of payments received to date. Each payment by the customer can be equal or alternatively, the payments early in the term of the lease can be greater than later payments to reflect the greater initial value of the equipment.

In one embodiment, the computer equipment lease can have a pre-set term (for example, 36 months) or, alternatively, the lease can be completely open-ended. In either embodiment, the customer can terminate the lease at an arbitrary point in time determined by the customer, without penalty to the customer. For example, in one embodiment, the lease can have no term and the customer can make monthly payments after completing each month of the lease. If the customer leases for a fraction of a month, the customer can make a fractional payment. Alternatively, the customer can pay in advance for each month, and, if the customer terminates the lease in the middle of the month, the customer forfeits the amount paid for the latter portion of the month. In either embodiment, the customer pays no separate penalty for terminating the lease early, aside from perhaps forfeiting a portion of a periodic payment.

In either of the foregoing embodiments, the termination tracker 120 can determine whether or not the lease for the computer equipment has been terminated by the customer in step 228. If the lease has not been terminated, the computer equipment lease tracker 118 continues to track lease information pertaining to the computer equipment. If the customer has terminated the lease, the computer termination tracker 120 can track the return of the computer to the manufacturer (step 230) and in step 232, the computer termination tracker 120 can indicate that the customer's termination of the lease results in no penalty to the customer.

In one embodiment, the manufacturer can determine whether to re-lease the returned piece of computer equipment to another customer (step 234). If the decision is made to re-lease the computer equipment, the manufacturer can optionally refurbish the components and/or the computer (step 242) and re-lease the computer to another customer (step 244). The computer lease tracker 118 then tracks the lease arrangement with the new customer and the foregoing process is repeated.

If the decision is made not to re-lease the computer equipment, the manufacturer then determines whether the computer equipment is to be sold (step 235). If the decision is not to sell the computer or if a buyer cannot be found, then the computer will not be disposed to a customer. Accordingly, the manufacturer can notify the vendor (step 237) and the grace period during which lease payments for the leased component in the computer equipment are suspended begins (step 218—see FIG. 2B). Alternatively, if the decision is made to sell the computer equipment, the manufacturer can purchase the component in the equipment from the vendor (step 236). In one embodiment, the purchase price can equal the remaining value of the components, i.e., the cost of the component less the sum of the payments made to date by the manufacturer for the component. Alternatively, the purchase price can be computed in accordance with other methodologies. In either embodiment, the component and/or the computer equipment can optionally be refurbished (step 238) and the computer can then be sold to another customer (step 240).

One feature of an embodiment of the system and method described above with reference to FIGS. 1 and 2A-2C is that the customer can return the leased computer equipment at an arbitrary point in time without suffering a termination penalty. Accordingly, an advantage to the customer is that the customer can more readily take advantage of rapid technology upgrades in the computer industry. In one aspect of this embodiment, the customer may be discouraged from returning the equipment after too short a period of time has passed because, for example, the customer may have to transfer data and application files to the new computer.

Another feature of an embodiment of the system and method described above with reference to FIGS. 1 and 2A-2C is that the manufacturer can lease computer components from the component vendor. An advantage of this arrangement to the manufacturer is that the manufacturer need not pay the full value of the computer components up front, but can instead extend the period for paying for the components by leasing the components. Furthermore, the manufacturer can terminate the lease of the computer component without penalty, for example, if the manufacturer is unable to release or sell the equipment in which the component is installed. Accordingly, the manufacturer need not make payments for components that are not generating revenue for the manufacturer.

An advantage of the foregoing arrangement to the vendor is that the manufacturer may commit to a larger order than under some conventional arrangements because the initial cash outlay per component is lower. Furthermore, the manufacturer may lease the components for a period of time that exceeds the length of time necessary for the vendor to recoup the cost of the component (plus interest), providing additional revenue for the vendor.

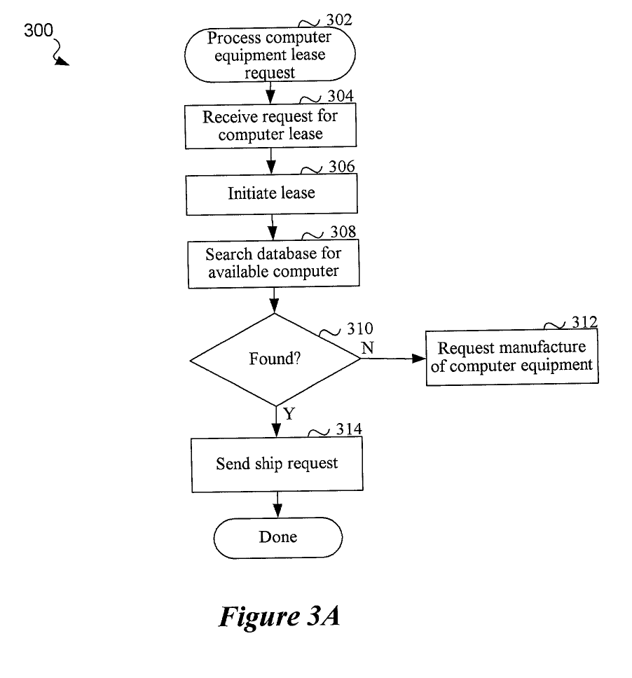

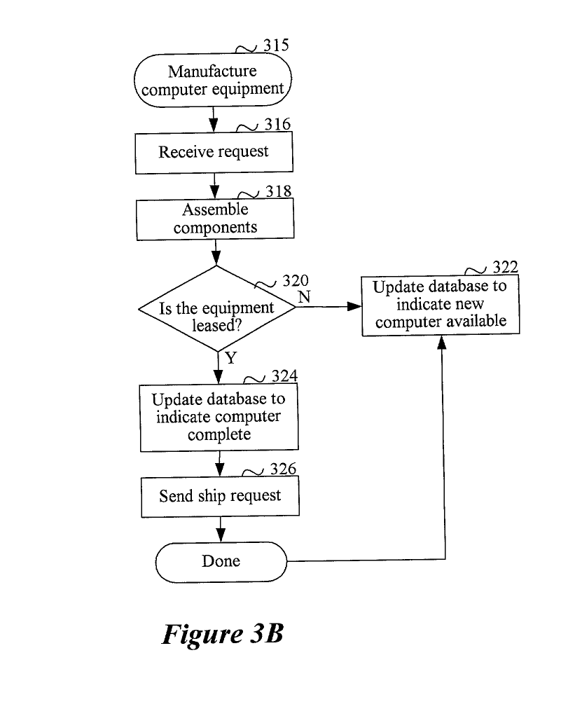

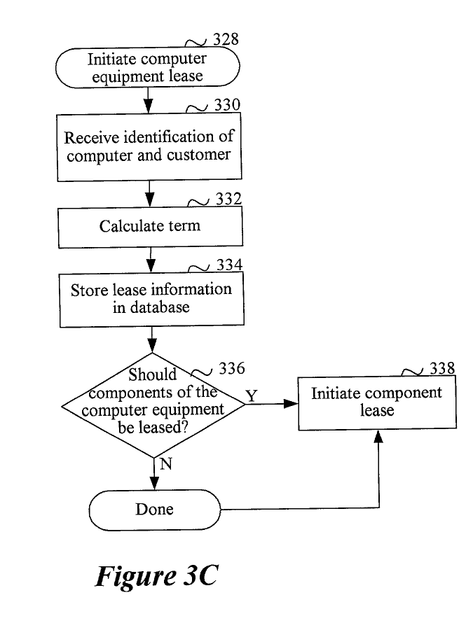

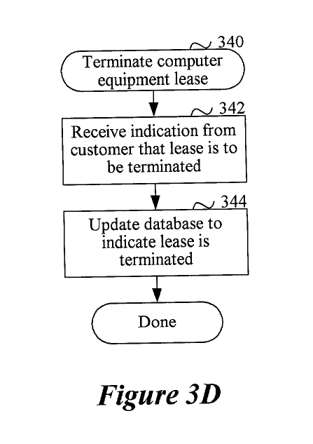

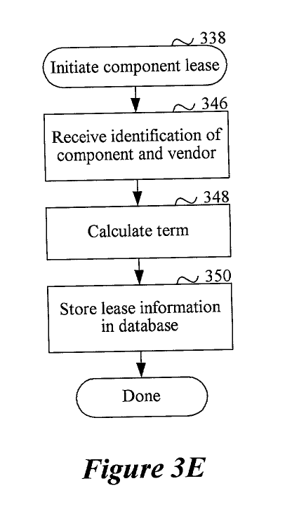

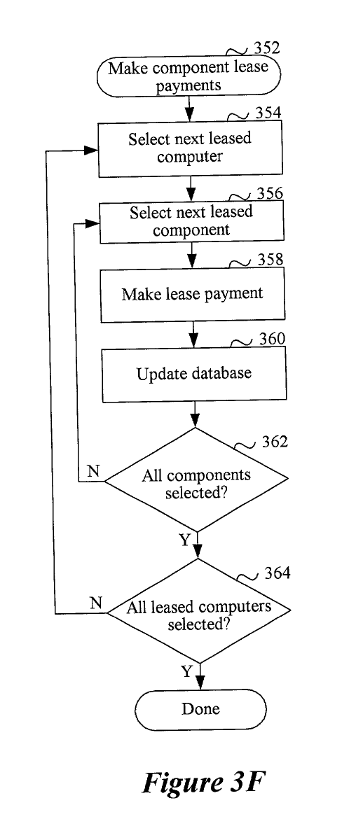

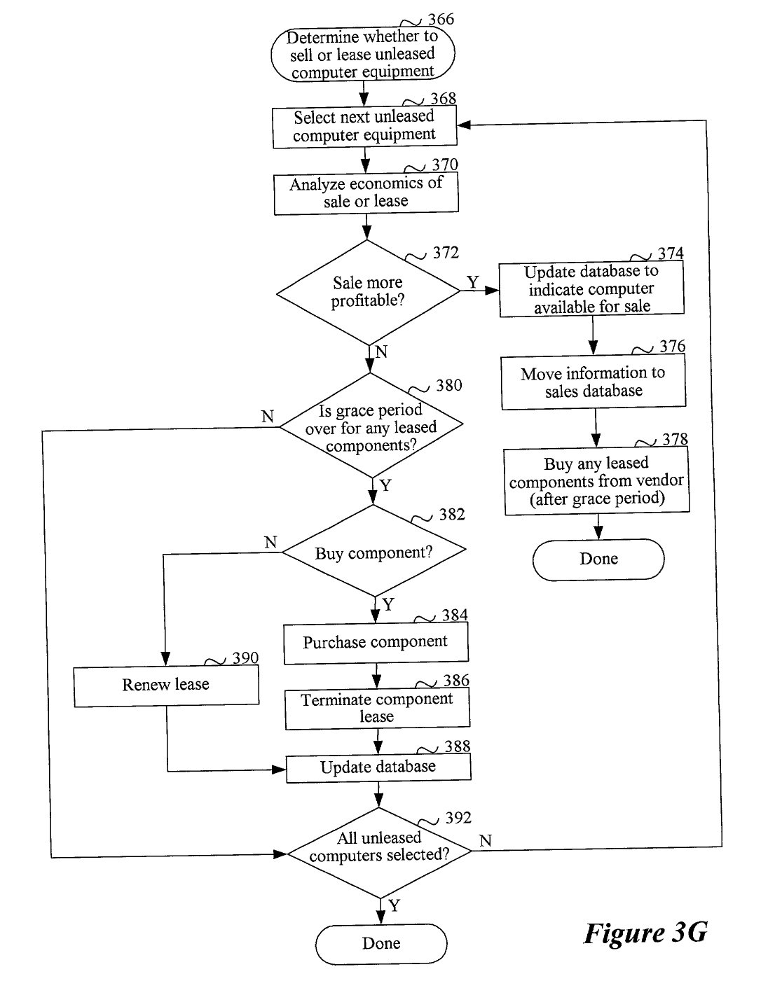

FIGS. 3A-3G are flow diagrams illustrating aspects of a method 300 for providing computer equipment in accordance with another embodiment of the invention. The method 300 can include some or all of the processes, subprocesses and steps described with reference to FIGS. 3A-3G. Beginning with FIG. 3A, the method 300 can include processing a computer equipment lease request (step 302) by receiving a request for a computer lease (step 304). In step 306, the lease is initiated (as described in greater detail below with reference to FIG. 3C) and in step 308 the method includes searching a database for an available computer. If an available computer is not found in step 310, a request to manufacture the computer equipment is issued in step 312. The equipment is then manufactured as discussed in greater detail below with reference to FIG. 3B. If the computer equipment is found in the database (step 310), a ship request is sent in step 314 to initiate shipping the computer equipment to the customer.

In FIG. 3B, the process can include manufacturing computer equipment (step 315). For example, the method can include receiving a request for the assembly or manufacture of the computer equipment (step 316), upon the basis of which components forming the computer equipment are assembled (step 318). In step 320, it is determined whether or not the computer equipment is leased. If the computer equipment is not leased, a database is updated in step 322 to indicate a new computer available for lease. If the equipment has been leased, then the database is updated in step 324 to indicate that the requested computer is complete, and a shipping request is submitted in step 326.

FIG. 3C illustrates a process 328 for initiating a computer equipment lease. In step 330, the identification of the computer equipment and the customer for the equipment are received. In step 332, the term of the lease is calculated and in step 334, information pertaining to the lease is stored in a database. In step 336, it is determined whether or not components of the computer equipment should be leased. If components of the computer equipment should be leased, a component lease for each leased component is initiated in step 338, as described in greater detail below with reference to FIG. 3E.

FIG. 3D is a flow diagram illustrating a process in accordance with the method for terminating the computer lease (340). The process can include receiving an indication from the customer to whom the computer equipment is leased that the lease is to be terminated (step 342). When the indication is received, the database can be updated to indicate that the lease is terminated (step 344) and, as described above with reference to FIGS. 1-2C, the lease can be terminated without having the customer incur a penalty.

FIG. 3E is a flow diagram illustrating aspects of the process 338 for initiating a component lease. In step 346, the identification of the component and the vendor from whom the component will be leased is received. In step 348, the term of the lease for the component is calculated. In step 350, the above information and further information pertaining to the lease of the computer component from the vendor is stored in a database.

FIG. 3F illustrates a process 352 which includes making component lease payments on components leased from an entity such as a component vendor. In step 354, the next piece of leased computer equipment is selected. In step 356, the next leased component in the leased computer equipment is selected. In step 358, the lease payment on the computer component is made and in step 360, the database is updated to indicate payment on the lease. In step 362, it is determined whether all the lease components have been selected. If not, the process returns to step 356 until all the components have been selected. Once all the leased components have been selected, it is determined (step 364) whether all the leased computers have been selected. If all the leased computers have not been selected, the process returns to step 354 until all the leased computers have been selected.

FIG. 3G illustrates another aspect of the process 300 which includes determining whether to sell or lease unleased computer equipment (366). In step 368, the next unleased piece of computer equipment is selected, and in step 370, the economics of whether to sell or lease the pieces of computer equipment are analyzed. In step 372, it is determined whether selling the piece of computer equipment is more profitable than leasing the computer equipment. If a sale is more profitable, then in step 374, the database is updated to indicate that the computer equipment is available for sale and in step 376, the information pertaining to the piece of computer equipment is moved to a sales database. In step 378, any leased components of the piece of computer equipment to be sold are purchased from the component vendor. In one aspect of this embodiment, any pending, unexpired grace period for components leased from the vendor can be allowed to expire before the components are purchased.

If, in step 372, it is determined that sale is not more profitable than leasing the computer equipment, then in step 380, it is determined whether any grace period for any leased components in the computer equipment has expired. If all the grace periods for leased components in the computer equipment have expired, then in step 382 it is determined whether or not to buy the leased components. If it is determined to buy the leased components, the components are purchased in step 384, the lease for the components is terminated in step 386, and the database is updated in step 388. If it is determined not to buy the components, then the lease for the components is renewed in step 390 and the database updated in step 388. In step 392, it is determined whether all unleased computers have undergone the economic analysis described above, and if not, the process returns to step 368 and is repeated until all unleased computer components have been selected.

From the foregoing it will be appreciated that although specific embodiments of the invention have been described herein for purposes of illustration, various modifications may be made without deviating from the spirit and scope of the invention. For example, the foregoing methods and systems may be applied to equipment and components other than computer equipment and components in other embodiments. Accordingly, the invention is not limited except as by the appended claims.

1. A method in a computer system for providing computer equipment to a customer, comprising:
receiving an indication of an available piece of the computer equipment;
updating a database to indicate a lease of the computer equipment to the customer in return for a payment from the customer corresponding at least in part to a length of time the customer leases the computer equipment;
receiving an indication from the customer that the lease is terminated after an arbitrary, customer-selected time period has elapsed, without incurring a penalty to the customer; and
updating the database to indicate that the computer equipment is received ii back from the customer.

2. The method of claim 1 wherein the customer is a first customer and the payment is a first customer payment, and wherein the method further comprises updating the database to indicate sale of the computer equipment to a second customer, or lease of the computer equipment to the second customer by providing the computer equipment to the second customer and receiving a second customer payment corresponding at least in part to the length of time the second customer leases the computer equipment.

3. The method of claim 1, further comprising:
indicating a commitment to leasing a selected number of computer components from a component vendor;
updating the database to indicate leasing at least one of the computer components from the vendor by receiving the computer component from the vendor and paying the vendor at predetermined intervals a periodic vendor payment corresponding to the cost of the computer component multiplied by an interest rate factor and divided by a total number of predetermined intervals that elapse until the estimated value of the component is zero; and
updating the database to indicate payment of the periodic vendor payment after the total number of predetermined intervals has elapsed.

4. The method of claim 3, further comprising updating the database to indicate purchasing the component from the vendor and selling the computer equipment to the other customer or leasing the computer equipment to another customer by providing the computer equipment to the other customer and receiving payments from the other customer while continuing to pay the vendor the periodic vendor payment.

5. The method of claim 1, further comprising:
indicating leasing of at least one of the components of the computer equipment from a vendor by receiving the component from the vendor and paying the vendor at predetermined intervals a periodic vendor payment corresponding to the cost of the component multiplied by an interest rate factor and divided by a number of time intervals that elapse until an estimated value of the component is zero; and
indicating purchasing the computer component from the vendor for a purchase amount after a selected number of time intervals have passed and after paying a selected number of periodic vendor payments, the purchase amount corresponding to a remaining value of the computer component.

6. The method of claim 1, further comprising:
indicating leasing of at least one component of the computer equipment from the vendor by receiving the component from the vendor and paying the vendor at predetermined intervals a periodic vendor payment corresponding to the cost of the component multiplied by an interest rate factor and divided by a number of time intervals that elapse until the value of the component is zero; and
indicating continuing to lease the components and pay the vendor the periodic vendor payment after the number of time intervals has passed.

7. The method of claim 1 wherein updating a database to indicate a lease of the computer equipment includes indicating receipt from the customer of a plurality of periodic payments having equal values.

8. The method of claim 1 wherein updating a database to indicate a lease of the computer equipment includes indicating receipt from the customer a plurality of periodic payments with each successive payment being less than the preceding payment.

9. The method of claim 1, further comprising:
indicating refurbishing of the components of the computer equipment after receiving the computer equipment back from the customer; and
indicating transmission of the computer equipment with the refurbished components to another customer.

10. The method of claim 1, further comprising indicating payment of an interest fee for the computer components.

11. A method for providing computer equipment to a customer, comprising:
leasing at least one component of the computer equipment from a vendor by receiving the component from the vendor and paying the vendor a periodic vendor payment;
installing the component in the computer equipment; and
leasing the computer equipment to a customer in return for payment from the customer corresponding at least in part to the length of time the customer leases the computer equipment.

12. The method of claim 11 wherein the customer is a first customer and the payment is a first customer payment, and wherein the method further comprises selling the computer equipment to a second customer, or leasing the computer equipment to the second customer by providing the computer equipment to the second customer and receiving a second customer payment corresponding at least in part to the length of time the second customer leases the computer equipment.

13. The method of claim 11, further comprising:
receiving an indication from the customer that the computer equipment lease is terminated after an arbitrary, customer-selected time period has elapsed, without incurring a penalty to the customer; and
receiving the computer equipment back from the customer.

14. The method of claim 13, further comprising:
ceasing to receive payment from the customer upon termination of the computer equipment lease; and
ceasing to pay the vendor for the computer component.

15. The method of claim 11 wherein installing the component in the computer equipment includes installing the component in a personal computer, notebook computer or server.

16. A method in a computer system for providing computer equipment to a customer, comprising:
updating a database to indicate that at least one component of the computer equipment is leased from a vendor, the lease including receiving the component from the vendor and paying the vendor a periodic vendor payment;
receiving an indication that the component is installed in the computer equipment;
updating a database to indicate that the computer equipment is leased to a customer in return for a payment from the customer corresponding at least in part to a length of time the customer leases the computer equipment; and
updating a database to indicate that the computer equipment is received back from the customer and the lease with the customer is terminated after an arbitrary, customer-selected period of time has elapsed without penalty to the customer.

17. The method of claim 16, further comprising updating a database to indicate continued payments to the vendor for the component after having paid the vendor a total amount for the component that is at least equal to an initial value of the component, while leasing the computer equipment to the customer or another customer.

18. The method of claim 16 wherein the customer is a first customer and the payment is a first customer payment, and wherein the method further comprises updating a database to indicate a sale of the computer equipment to a second customer, or a lease of the computer equipment to the second customer by providing the computer equipment to the second customer and receiving a second customer payment corresponding at least in part to the length of time the second customer leases the computer equipment.

19. A method for providing computer equipment to customers, comprising:
leasing at least one component of the computer equipment from a vendor by receiving the component from the vendor and paying the vendor a periodic vendor payment;
installing the component into the computer equipment;
leasing the computer equipment to a first customer by providing the computer equipment to the first customer and receiving a first customer payment corresponding at least in part to a length of time the computer equipment is leased by the first customer;
receiving the computer equipment back from the first customer after an arbitrary customer-selected period of time has elapsed without penalty to the customer;
ceasing to receive the first customer payment;
purchasing the component from the vendor;
selling the computer equipment to a second customer, or leasing the computer equipment to the second customer by providing the computer equipment to the second customer and receiving a second customer payment corresponding to a length of time the computer equipment is leased by the second customer while continuing to pay the vendor the periodic vendor payment.

20. The method of claim 19 wherein the component is a component of a personal computer and installing the component includes installing the component in a personal computer, notebook computer or server.

21. The method of claim 19, further comprising:
ceasing to pay the vendor the periodic vendor payment for the computer component during a period when the computer equipment is not leased or sold to a customer.

22. A method for obtaining computer equipment, comprising:
leasing the computer equipment from a leasing entity by receiving the computer equipment from the entity and paying to the entity at least one periodic payment corresponding at least in part to a length of time the computer equipment is leased from the entity; and
returning the computer equipment to the entity without penalty after an arbitrary period of time has elapsed.

23. The method of claim 22 wherein leasing the computer equipment from the leasing entity includes paying the entity a plurality of periodic payments having equal values.

24. The method of claim 22 wherein leasing the computer equipment from the entity includes paying the entity a plurality of periodic payments with each successive payment being less than the preceding payment.

25. The method of claim 22 wherein leasing the computer equipment includes leasing a personal computer, notebook computer or server.

26. The method of claim 22, further comprising paying the periodic payment before the start of the period for which the computer equipment is leased.

27. A method in a computer system for providing computer components to a component assembler, comprising:
updating a database to indicate receiving from the assembler a commitment to lease at least a selected number of computer components;
updating a database to indicate leasing each computer component to the assembler, the leasing including providing the computer components to the assembler and receiving a plurality of periodic payments from the assembler; and
indicating continued periodic payments from the assembler for at least one of the components after having received total payments from the vendor for the computer component at least equal to an initial value of at least one computer component.

28. The method of claim 27, further comprising indicating ceasing to receive periodic payments from the assembler while a piece of computer equipment in which the at least one component is installed and is not leased or sold to a customer of the assembler.

29. The method of claim 27 wherein indicating continued periodic payments from the assembler includes indicating periodic payments received while a piece of the computer equipment in which the at least one component is installed is leased to a customer of the assembler.

30. A computer-readable medium, the contents of which perform a method for tracking computer leasing information, the method comprising:
tracking an identity of a piece of computer equipment;
tracking lease payments made by a customer leasing the piece of computer equipment;
receiving an indication that the customer has terminated the lease of the computer equipment at an arbitrary, customer-selected point in time; and
ceasing to track lease payments made by the customer without incurring penalty to the customer for terminating the lease at the arbitrary, customer-selected point in time.

31. The computer-readable medium of claim 30 wherein the method further comprises:
tracking an identity of a component of the computer equipment leased from a component vendor; and
tracking lease payments made to the component vendor.

32. A computer system for tracking computer leasing information, comprising:
an identity tracker capable of tracking an identity of a piece of computer equipment;
a lease payment tracker capable of tracking lease payments made by a customer leasing the piece of computer equipment; and
a termination tracker capable of receiving an indication that the customer has terminated the lease of the computer equipment at an arbitrary customer-selected point in time without incurring a penalty to the customer for terminating the lease at the customer-selected point in time.

33. The computer system of claim 32 wherein the identity tracker is a first identity tracker and the lease payment tracker is a first lease payment tracker, and wherein the system further comprises:
a second identity tracker capable of tracking an identity of a component of the piece of computer equipment leased from a component vendor; and
a second lease payment tracker capable of tracking lease payments made to a component vendor for the component of the piece of computer equipment.
